(19) United States
(12) Patent Application Publication
(10) Pub. No.: US 2026/0231930 A1
(43) Pub. Date: Aug. 13, 2026

(54) OIL DISPERSION COMPOSITIONS AND USES THEREOF

(71) Applicant: ADAMA AGAN LTD., Ashdod (IL)

(72) Inventors: Vladimir GUBRIY, Ashdod (IL); David MOCATTA, Gedera (IL); Gilad SILBERT, Kibbutz Dorot (IL)

(73) Assignee: ADAMA AGAN LTD., Ashdod (IL)

(21) Appl. No.: 19/471,323

(22) PCT Filed: Mar. 27, 2024
(86) PCT No.: PCT/IL2024/050315

§ 371 Date: Sep. 30, 2025

(30) Foreign Application Priority Data
Mar. 31, 2023 (EP) 23165783.4

(51) Int. Cl. A01N 25/04; A01N 43/56; A01N 43/90; A01N 47/36; A01N 47/38; A01P 13/00

(52) U.S. Cl. CPC A01N 25/04; A01N 43/56; A01N 43/90; A01N 47/36; A01N 47/38; A01P 13/00

(57) ABSTRACT

The present invention provides an oil dispersion (OD) composition comprising one or more herbicides and a combination of particular dispersants and surfactants. The OD compositions of the invention are useful in controlling weed.

### TECHNICAL FIELD

The present invention relates to an oil dispersion (OD) composition comprising one or more herbicides and a combination of particular additives. The OD compositions of the invention are useful in controlling weed.

### BACKGROUND ART

An oil dispersion (OD) formulation is a stable suspension of active ingredient(s) in a water immiscible fluid, which may contain other dissolved active ingredient(s) and is especially suitable for water-sensitive or non-soluble active ingredients, making the OD formulations very efficient and environmentally friendly agrochemical formulations.

OD formulations are applied by dilution in water and when diluted in the spray tank the formulation should form a stable mixture of emulsified oil droplets and dispersed particles. Diluting the OD formulation in water can produce an emulsion, in case the active ingredient is itself water soluble, or a suspoemulsion, in case the active ingredient shows low water solubility.

Common disadvantages seen in OD formulations include, e.g., physically unhomogeneous appearance, phase separation over time or formation of non-flowable cream, poor emulsion and dispersion upon dilution.

Specifically, adding an OD formulation to water in the tank spray can lead to physical incompatibility of the formulation such as separation into layers (that is, oil and water), clumping of solids, and formation of gels, which could lead to the blockage of spray nozzles and make it difficult to apply. Such physical incompatibility can cost time and effort since operators may have to drain and flush the tanks, and then remove and clean all filters, screens, and nozzles, in order to clean out gels, solids, and hard-packed sediments formed. Additionally, it can be expensive to remediate and safely dispose of the residues and any waste generated while cleaning the sprayer.

Finding appropriate auxiliaries (additives) which can help overcome the physical incompatibility upon dilution of OD formulations with water is challenging for several reasons. For instance, competitive adsorption within OD formulation, wherein oil carrier competes with dispersants for the opportunity to be adsorbed on the surface of active ingredient(s) particles, can lead to a situation where a large part of dispersant molecules do not function due to failure in adsorption. Poor adsorption of dispersants on surface of active ingredient(s) particles in an orderly manner can lead to aggregation of the particles.

Therefore, there is a need for OD formulations comprising suitable oil-compatible auxiliaries (additives) such as dispersants and surfactants which enable forming a stable emulsion after dilution of said OD formulations with water, while maintaining the chemical stability of the active ingredients as well as their activity in the field.

### SUMMARY OF INVENTION

It has now been found, in accordance with the present invention, that herbicidal oil dispersion (OD) compositions comprising a combination of particular additives, more specifically, a combination comprising a dispersant selected from an alkylated N-vinylpyrrolidinone copolymer, an alkyd polyethylene glycol resin, a polyhydroxy ester-polyethylene glycol copolymer, a star structure polymer, and a mixture thereof; and a surfactant selected from polyethylene glycol sorbitol ester of fatty acids, formed stable emulsions upon dilution with water, wherein the amount of gel-like residue was significantly reduced.

For example, and as shown in the Experimental section herein, particular such OD compositions comprising a mixture of the herbicides pinoxaden and either thiencarbazone-methyl or mesosulfuron-methyl and a combination of additives comprising the surfactant Atlas® G-1086 and a dispersant selected from Zephrym™ PD 2206, Atlox™ 4916, Atlox™ 4914, and Agrimer™ AL 22, upon dilution with water, formed stable emulsions having significantly reduced amount of gel-like residue. This finding is highly important as it enables applying OD formulations comprising one or more herbicides efficiently, without dealing with problems such as blockage of spray nozzles upon application, while maintaining the chemical stability of the one or more herbicides comprised within the OD formulations.

Moreover, and in fact as shown herein, a pinoxaden- and thiencarbazone-methyl-based OD composition comprising the dispersant Zephrym™ PD 2206 and the surfactant Atlas® G-1086, was equivalent or superior to a tank mix consisting of two separate products each containing one of said two herbicides, in controlling the grassy weeds Avena sativa, Setaria verticillata, and Lolium multiflorum. Such an herbicidal OD composition is highly beneficial since the application thereof to a locus such as a field of crop would be much more convenient than applying each one of the herbicides from a separate composition.

In one aspect, the present invention thus relates to an oil dispersion (OD) composition comprising: (i) one or more herbicides; (ii) a dispersant selected from a polyhydroxy ester-polyethylene glycol copolymer, an alkylated N-vinylpyrrolidinone copolymer, an alkyd polyethylene glycol resin, a star structure polymer, and a mixture thereof, (iii) a surfactant selected from polyethylene glycol sorbitol ester of fatty acids; and (iv) an oil.

In certain embodiments, said polyethylene glycol sorbitol ester of fatty acids is: (i) a polyethylene glycol sorbitol ester of oleic acid such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); (ii) a polyethylene glycol sorbitol ester of a mixture of oleic and lauric acids such as polyoxyethylene (30) oleate-laurate (e.g., Atlox™ 1045A); or (iii) a mixture thereof, and/or said polyhydroxy ester-polyethylene glycol copolymer is a block copolymer of polyethylene glycol and poly(12-hydroxystearic acid) (e.g., Zephrym™ PD 2206, Hypermer™ B246, and Atlox™ 4912), said alkylated N-vinylpyrrolidinone copolymer is a copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30); said alkyd polyethylene glycol resin is a copolymer of polyisobutylene succinic anhydride and polyethylene glycol (e.g., Atlox™ 4914); and said star structure polymer is a polyethylene glycol sorbitol polyester of fatty acids, i.e., an ethoxylated sorbitol esterified with a polyester having, e.g., 2-6, fatty acid chains (e.g., Atlox™ 4916).

In another aspect, the present invention relates to methods for using an OD herbicidal composition as defined above. For example, in a particular such aspect, disclosed herein is a method of controlling weed comprising applying to a locus, such as a field of crop, an effective amount of such an OD composition.

### BRIEF DESCRIPTION OF DRAWINGS

FIG. 1 shows the efficacy (% control) at 5, 12, 19, and 26 days after application (DAA) of the pinoxaden-thiencarbazone-based formulations (pinoxaden+thiencarbazone OD and pinoxaden+thiencarbazone OD+adj) at application rate (in ml of active ingredient per dunam; ml du⁻¹) of 45 and 60 (equals to 75% and 100% of field target rate, respectively), and a tank mix (pinoxaden 100 EC+Varro+adj), in controlling Avena sativa when applied post-emergence. * adj refers to the adjuvant Agral (nonyl phenol ethylene oxide condensate), added at 0.25% v/v.

FIG. 2 shows the efficacy (% control) at 5, 12, 19, and 26 days after application (DAA) of the pinoxaden-thiencarbazone-based formulations (pinoxaden+thiencarbazone OD and pinoxaden+thiencarbazone OD+adj) at application rate (in ml of active ingredient per dunam; ml du⁻¹) of 45 and 60 (equals to 75% and 100% of field target rate, respectively), and a tank mix (pinoxaden 100 EC+Varro+adj), in controlling Setaria verticillata when applied post-emergence. * adj refers to the adjuvant Agral (nonyl phenol ethylene oxide condensate), added at 0.25% v/v.

FIG. 3 shows the efficacy (% control) at 5, 12, 19, and 26 days after application (DAA) of the pinoxaden-thiencarbazone-based formulations (pinoxaden+thiencarbazone OD and pinoxaden+thiencarbazone OD+adj) at application rate (in ml of active ingredient per dunam; ml du⁻¹) of 45 and 60 (equals to 75% and 100% of field target rate, respectively), and a tank mix (pinoxaden 100 EC+Varro+adj), in controlling Lolium multiflorum when applied post-emergence. * adj refers to the adjuvant Agral (nonyl phenol ethylene oxide condensate), added at 0.25% v/v.

### DETAILED DESCRIPTION

In one aspect, the present invention relates to an oil dispersion (OD) composition comprising: (i) an herbicide; (ii) a dispersant selected from a polyhydroxy ester-polyethylene glycol copolymer, an alkylated N-vinylpyrrolidinone copolymer, an alkyd polyethylene glycol resin, a star structure polymer, and a mixture thereof; (iii) a surfactant selected from polyethylene glycol sorbitol ester of fatty acids; and (iv) an oil.

The term “surfactant” as used herein refers to an agriculturally acceptable surface-active molecule, which is partially hydrophilic (water-soluble) and partially lipophilic (soluble in lipids, or oils), that is added to an OD formulation and reduces the surface tension of the oil phase. The surfactant is used not only to stabilize the dispersion and to emulsify the oil upon dilution in water, but also to increase the suspension stability, wetting ability, penetration and translocation of a product after dilution.

Particular polyethylene glycol sorbitol esters of fatty acids referred to herein are a polyethylene glycol sorbitol ester of oleic acid (i.e., polyethylene glycol sorbitol oleate) such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); and a polyethylene glycol sorbitol ester of a mixture of oleic and lauric acids (i.e., polyethylene glycol sorbitol oleate-laurate) such as polyoxyethylene (30) oleate-laurate (e.g., Atlox™ 1045A).

The term “dispersant” as used herein refers to an agriculturally acceptable material which improves the stability of an OD herbicidal formulation, either of the formulation itself where the solids are suspended for a long time or in the spray tank after being mixed with water, by improving the separation of the particles and preventing their setting or clumping, e.g., by inhibiting crystal growth or avoiding particle agglomeration.

Particular polyhydroxy ester-polyethylene glycol copolymers referred to herein are ABA copolymers of polyhydroxy ester-polyethylene glycol-polyhydroxy ester such as a block copolymer of polyethylene glycol and poly(12-hydroxystearic acid) (e.g., Zephrym™ PD 2206, Hypermer™ B246, and Atlox™ 4912).

Particular alkylated N-vinylpyrrolidinone copolymers referred to herein are copolymers of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30).

Particular alkyd polyethylene glycol resins referred to herein are copolymers of polyisobutylene succinic anhydride and polyethylene glycol (e.g., Atlox™ 4914).

A non-limiting example of a star structure polymer referred to herein include a polyethylene glycol sorbitol polyester of fatty acids, i.e., an ethoxylated sorbitol esterified with a polyester having, e.g., 2-6, fatty acid chains (e.g., Atlox™ 4916). According to the literature, a polyethylene glycol sorbitol polyester of fatty acids could be prepared by reacting sorbitol with ethylene oxide and then further reacting the obtained intermediate with polymerized fatty acids.

In certain embodiments, the amount of the surfactant comprised within the OD composition of the invention is from about 0.5% to about 30%, e.g., from about 1% to about 25%, from about 2% to about 20%, or from about 2.5% to about 18%, by weight; and/or the amount of the dispersant comprised within the OD composition of the invention is from about 0.1% to about 15%, e.g., from about 0.2% to about 10%, or from about 0.5% to about 8%, by weight.

It should be noted, that each one of the dispersants and surfactants mentioned throughout this specification includes any commercially available product comprising or consisting essentially of a particular such dispersant or surfactant. The term “consisting essentially of” as used herein with respect to said commercially available product means that said product comprises at least 90%, but preferably at least about 92%, 94%, 96%, 98%, or 99%, by weight, of said particular dispersant or surfactant, such that any other material if included within said product does not affect the basic physical and chemical properties of said dispersant or surfactant.

In certain embodiments, the oil comprised within the composition of the invention is a triglyceride fatty acid ester such as a vegetable oil, seed oil, and animal oil; or a monoester derived from a vegetable, seed, or animal oil; or a mixture thereof.

Non-limiting examples of vegetable oils include soybean oil, olive oil, almond oil, canola oil, omega-9 canola oil, castor oil, coconut oil, corn oil, palm oil, peanut oil, safflower oil, sesame oil, and tung oil; and non-limiting examples of seed oils include rape seed oil, sunflower seed oil, cotton seed oil, and linseed oil.

In certain embodiments, the OD composition of the invention according to any one of the embodiments above further comprises a safener.

The term “safener” as used herein refers to a compound that is added to herbicidal formulations to eliminate or reduce phytotoxic effects of the herbicide to certain crops. These compounds are used to protect crops from injury by herbicides but typically do not prevent the herbicide from controlling undesired vegetation.

Non-limiting examples of safeners include benoxacor, cloquintocet, cumyluron, cyometrinil, cyprosulfamide, 2-(dichloromethyl)-2-methyl-1,3-dioxolane (MG 191), 4-(dichloroacetyl)-1-oxa-4-azospiro[4.5]decane (MON 4660), dichlormid, dicyclonon, dietholate, daimuron, dimepiperate, fenchlorazole ethyl, fenclorim, flurazole, fluxofenim, furilazole, isoxadifen ethyl, mefenpyr diethyl, mephenate, naphthalic anhydride, methoxyphenone, oxabetrinil, and a derivative thereof such as agriculturally acceptable salt and an ester thereof (e.g., cloquintocet-mexyl).

In certain embodiments, the OD composition of the invention according to any of the embodiments above further comprises a thickening agent.

The term “thickening agent” as used herein refers to an additive that is added to an agrochemical formulation to increase its viscosity and prevent sedimentation of the active ingredient(s), thereby conferring greater stability and allowing storage thereof for a longer period.

In particular such embodiments, the thickening agent is a clay, a modified clay, silica, a modified silica, or a mixture thereof.

Non-limiting examples of modified clays include organically modified clays such as organo-modified montmorillonite, organo-modified bentonite, and organo-modified attapulgite; non-limiting examples of silica include hydrophilic fumed silica (e.g., Aerosil® 90, Aerosil® 130, Aerosil® 150, Aerosil® 200, Aerosil® 200F, Aerosil® 300, Aerosil® 380, Aerosil® 380F, Aerosil® OX 50, Aerosil® TT600, CAB-O-SIL® HS-5, CAB-O-SIL® M-5, CAB-O-SIL® M-5F, CAB-O-SIL® EH-5, CAB-O-SIL® LM-150, and CAB-O-SIL®H-300); and non-limiting examples of modified silicas include an organo-modified silica such as hydrophobic fumed silica (e.g., Aerosil® R805, Aerosil® R 812 S, Aerosil® R 972, Aerosil® R 974, Aerosil® R 976, Aerosil® R104, Aerosil® R106, Aerosil® R208, Aerosil® R7200, Aerosil® R8200, Aerosil® R9200, Aerosil® R711, Aerosil® R816, Aerosil® R 202, CAB-O-SIL® TS-720, CAB-O-SIL® TS-710, CAB-O-SIL® TS-622, CAB-O-SIL® TS-530, CAB-O-SIL® TS-382, CAB-O-SIL® TS-5022, CAB-O-SIL CLARUS™ 6560, and CAB-O-SIL® ULTRABOND™ 5780).

In certain embodiments, the herbicide comprised within the OD composition of the invention according to any one of the embodiments above is an acetyl CoA carboxylase inhibitor, an acetolactate synthase (ALS) inhibitor, or a mixture thereof.

The Herbicide Resistance Action Committee (HRAC) classifies herbicides into different groups according to their target sites, modes of action, symptoms induced, and/or chemical classes. One of those groups are the acetyl CoA carboxylase (ACCase) inhibitors which include aryloxyphenoxypropionate (FOP)-, cyclohexanedione (DIM)-, and phenylpyrazolin (DEN)-based herbicides. The ACCase inhibitors are primarily used for postemergence grass control in broadleaf crops and absorbed through the foliage and translocated in the phloem to the growing point, where they inhibit meristematic activity. These herbicides inhibit the enzyme acetyl-CoA carboxylase, which catalyzes the first step in fatty acid synthesis and is important for membrane synthesis. In general, broadleaf species are naturally resistant to FOPs, DIMs, and DENs herbicides because of a less sensitive ACCase enzyme. However, ACCase inhibiting herbicides may cause symptoms on certain broadleaf crops. Natural tolerance of some grasses is due to a less sensitive ACCase enzyme or a higher rate of metabolic degradation.

Non-limiting examples of ACCase inhibitors include aryloxyphenoxypropionate (FOP)-based herbicides such as haloxyfop-methyl, metamifop, quizalofop-ethy, fenoxaprop-ethy, fenthiaprop, fluazifop-butyl, clodinafop-propargyl, cyhalofop-buty, and diclofop-methyl; cyclohexanedione (DIM)-based herbicides such as clethodim, cycloxydim, profoxydim, sethoxydim, tepraloxydim, and tralkoxydim; and phenylpyrazolin (DEN)-based herbicides such as pinoxaden.

Pinoxaden ([8-(2,6-diethyl-4-methylphenyl)-7-oxo-1,2,4,5-tetrahydropyrazolo [1,2-d][1,4,5]oxadiazepin-9-yl]2,2-dimethylpropanoate) is a herbicide for post-emergence control of annual grass weeds such as blackgrass, bluegrass, common windgrass, reed canary grass, foxtail, and Avena spp., in some cereal crops such as winter and spring barley, winter wheat, durum wheat, rye, and triticale.

Another group of herbicides include herbicides that inhibit the ALS enzyme, (also known as acetohydroxy acid synthase (AHAS) enzyme), which is a protein found in plants and micro-organisms, which catalyzes the first step in the synthesis of the branched-chain amino acids (valine, leucine, and isoleucine). ALS inhibitors affect many species of higher plants as well as bacteria, fungi, yeasts, and algae. This class of chemicals slowly starve affected plants of these amino acids, which eventually leads to inhibition of DNA synthesis. They affect grasses and dicots alike. The ALS inhibitor family includes sulfonylureas, imidazolinones, triazolinines, triazolopyrimidines, pyrimidinyl benzoates, and sulfonanilides. Weeds quickly become resistant to ALS inhibitors, presumably because these herbicides have a single mode of action and because many have long residual activity (Whitcomb, Toxicol Ind Health, 1999, 231-239).

Non-limiting examples of ALS inhibitors include triazolinone-based herbicides such as thiencarbazone-methy, flucarbazone-Na, and propoxy-carbazone-Na; sulfonylurea-based herbicides such as metsulfuron-methyl, mesosulfuron-methyl, nicosulfuron, and triasulfuron; sulfonanilide-based herbicides such as triafamone and pyrimisulfan; pyrimidinyl benzoate-based herbicides such as bispyribac-Na, pyribenzoxim, and pyriftalid; and triazolopyrimidine-based herbicides such as cloransulam-methy, flumetsulam, pyroxsulam, and penoxsulam.

Thiencarbazone-methy (methyl 4-[(3-methoxy-4-methyl-5-oxo-1,2,4-triazole-1-carbonyl)sulfamoyl]-5-methylthiophene-3-carboxylate) is applied on corn, wheat, turf and ornamentals in an uncontrolled manner. Application of thiencarbazone-methy can either be pre-plant, pre-emergent, or post-emergent (Janak T. W., and Grichar W. J. Weed control in corn (Zea mays L.) as influenced by preemergence herbicides. International Journal of Agronomy, 2016.).

Mesosulfuron-methyl (methyl 2-[(4,6-dimethoxypyrimidin-2-yl) carbamoylsulfamoyl]-4-(methanesulfonamidomethyl) benzoate) is a sulfonylurea-based post-emergence herbicide used to control grassy weeds in wheat and other cereal crops, and is an important herbicide for cereals (Kuk Y. I., and Bugos N. R. Cross-resistance profile of mesosulfuron-methyl-resistant Italian ryegrass in the southern United States. Pest Management Science: formerly Pesticide Science, 2007, 63, 349-357).

In particular such embodiments, the herbicide comprised within the OD composition of the present invention according to any one of the embodiments above consists of a mixture of two herbicides each independently selected from the group consisting of an acetyl CoA carboxylase inhibitor or an acetolactate synthase (ALS) inhibitor. More particular such embodiments are those wherein one of the herbicides is an acetyl CoA carboxylase inhibitor; and the other one is an acetolactate synthase (ALS) inhibitor. Still more particular such embodiments are those wherein said acetyl CoA carboxylase inhibitor is pinoxaden; and said ALS inhibitor is a triazolinone-based herbicide such as thiencarbazone-methyl or a sulfonylurea-based herbicide such as mesosulfuron-methyl.

Specific OD formulations shown herein comprise the herbicides pinoxaden and thiencarbazone-methyl; or pinoxaden and mesosulfuron-methyl.

In certain embodiments, the OD composition of the invention comprises: (i) an herbicide; (ii) a dispersant selected from a polyhydroxy ester-polyethylene glycol copolymer, an alkylated N-vinylpyrrolidinone copolymer, an alkyd polyethylene glycol resin, a star structure polymer, and a mixture thereof; (iii) a surfactant selected from polyethylene glycol sorbitol ester of fatty acids; (iv) an oil; (v) a safener; and (vi) a thickening agent, each as defined in any one of the embodiments above, and optionally further comprises an antioxidant.

Non-limiting examples of suitable antioxidants include butylated hydroxy toluene, butylated hydroxy anisole, tert-butyl hydroquinone, and n-propyl gallate.

In particular such embodiments, such an OD composition comprises, as said herbicide, a mixture of two herbicides each independently selected from the group consisting of an acetyl CoA carboxylase inhibitor and an acetolactate synthase (ALS) inhibitor. More particular such OD compositions are those wherein one of the herbicides is an acetyl CoA carboxylase inhibitor; and the other one is an acetolactate synthase (ALS) inhibitor.

Specific such OD compositions comprise from about 3% to about 20% by weight said acetyl CoA carboxylase; from about 0.4% to about 10% by weight said acetolactate synthase (ALS) inhibitor; from about 0.2% to about 10% by weight said dispersant; from about 1% to about 25% by weight said surfactant; from about 40% to about 95% by weight said oil; from about 1% to about 10% by weight said safener; and from about 1% to about 10% by weight said thickening agent.

Examples of such compositions are those wherein said acetyl CoA carboxylase inhibitor is pinoxaden; said acetolactate synthase inhibitor is a triazolinone-based herbicide such as thiencarbazone-methyl or a sulfonylurea-based herbicide such as mesosulfuron-methyl; said dispersant is at least one, e.g., one, two, three, or more, of: (i) a block copolymer of polyethylene glycol and poly(12-hydroxystearic acid) (e.g., Zephrym™ PD 2206, Hypermer™ B246, and Atlox™ 4912), (ii) a copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30), (iii) a copolymer of polyisobutylene succinic anhydride and polyethylene glycol (e.g., Atlox™ 4914), and (iv) a polyethylene glycol sorbitol polyester of fatty acids, i.e., an ethoxylated sorbitol esterified with a polyester having, e.g., 2-6, fatty acid chains (e.g., Atlox™ 4916); said surfactant is a polyethylene glycol sorbitol oleate such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); said oil is a vegetable oil such as canola oil; said safener is mefenpyr-diethyl; and said thickening agent is an organo-modified silica such as hydrophobic fumed silica.

More specific such compositions comprise:
(i) from about 5% to about 15% by weight pinoxaden; from about 0.5% to about 2% by weight thiencarbazone-methyl; from about 0.5% to about 8% by weight said block copolymer of polyethylene glycol and poly(12-hydroxystearic acid) (e.g., Zephrym™ PD 2206, Hypermer™ B246, and Atlox™ 4912); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica;
(ii) from about from about 5% to about 15% by weight pinoxaden; from about 0.5% to about 2% by weight thiencarbazone-methyl; from about 0.5% to about 8% by weight said polyethylene glycol sorbitol polyester of fatty acids, i.e., an ethoxylated sorbitol esterified with a polyester having, e.g., 2-6, fatty acid chains (e.g., Atlox™ 4916); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica;
(iii) from about from about 5% to about 15% by weight pinoxaden; from about 0.5% to about 2% by weight thiencarbazone-methyl; from about 0.5% to about 8% by weight said copolymer of polyisobutylene succinic anhydride and polyethylene glycol (e.g., Atlox™ 4914); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica; or
(iv) from about from about 2% to about 15% by weight pinoxaden; from about 0.5% to about 3% by weight mesosulfuron-methyl; from about 0.5% to about 8% by weight said copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30); from about 2% to about 10% by weight said polyoxyethylene sorbitol oleate; from about 50% to about 90% by weight said vegetable oil; from about 1% to about 8% by weight mefenpyr-diethyl; from about 1% to about 6% by weight said hydrophobic fumed silica; and from about 2% to about 8% by weight said antioxidant.

In another aspect, the present invention relates to various agricultural uses, e.g., pre- and/or post-emergence weed control, in which an OD composition as defined in any one of the embodiments above is utilized.

In one particular such aspect, disclosed herein is a method of controlling weed, also referred to herein as undesired vegetation, comprising applying to a locus an effective amount of an OD composition as defined herein.

The term “locus” as used herein refers not only to areas where the weed may already be developed, but also to areas where weeds have yet to emerge, and to areas under cultivation. Locus includes the crop and propagation material of the crop (all the generative parts of the crop such as seeds and vegetative plant material such as cuttings and tubers, which can be used for the multiplication of the plant. Examples of propagation material of the crop include seeds, tubers, spores, corms, bulbs, rhizomes, sprouts basal shoots, stolons, buds and other parts of plants, including seedlings and young plants, which could be transplanted after germination or after emergence from soil). Locus also includes the area surrounding the crop and the growing media of the crop, such as soil and crop field.

In certain embodiments, the locus is a field of crop. The term “crop” (or “plant”) as used herein refers to whole plants, plant organs (e.g., leaves, stems, twigs, roots, trunks, limbs, shoots, fruits, etc.), plant cells, or plant seeds. Non-limiting examples of crops are cotton, rice, banana, potato, coffee, sugar cane, citrus, beans, sunflower, apple, corn, soybean, wheat, barley, oats, chickpeas, fruit trees, nut trees, lentils, and grain sorghum. Yet, it should be clear that the list of crops provided herein is general, and the particular crop(s) treatable according to the method of the invention will depend on the specific herbicides comprised within the composition applied to the locus. The specific herbicides composing said composition may also affect the decision whether the composition is to be applied to the locus treated pre- or post-emergence of weeds.

Weeds that can be controlled by the method of the present invention include any weed, e.g., an annual or perennial grass or broad-leaved weed, that is sensitive to at least one of the herbicides comprised within the composition applied, e.g., to an acetyl CoA carboxylase inhibitor such as pinoxaden; and/or an acetolactate synthase inhibitor such as a triazolinone-based herbicide (e.g., thiencarbazone-methyl) and a sulfonylurea-based herbicide (e.g., mesosulfuron-methyl), and thus could be controlled by either pre- or post-emergence application of said herbicide(s). Non-limiting examples of such weeds are grassy weeds such as Avena sativa, Setaria verticillata, Triticum aestivum, Apera spica-venti, Bromus sp, Lolium rigidum, Lolium multiflorum, Lolium perenne, Poa annua, Poa trivialis, Phaeoseptoria sp., Milium vernale; and broad-leaved weeds such as Anagallis arvensis, Anthemis arvensis, oilseed rape Brassica napus, Capsella bursa-pastoris, Ridolfia segetum, Descurainia Sophia, Diplotaxis virgata, Diplotaxis virgata, Sinapis alba, Sinapis arvensis, Stellaria media, and Thlaspi arvense.

In certain embodiments, the OD composition used according to the method disclosed herein comprises: (i) an herbicide; (ii) a dispersant selected from a polyhydroxy ester-polyethylene glycol copolymer, an alkylated N-vinylpyrrolidinone copolymer, an alkyd polyethylene glycol resin, a star structure polymer, and a mixture thereof; (iii) a surfactant selected from polyethylene glycol sorbitol ester of fatty acids; (iv) an oil; (v) a safener; and (vi) a thickening agent, each as defined in any one of the embodiments above, and optionally further comprises an antioxidant.

In particular embodiments, such an OD composition comprises, as said herbicide, a mixture of two herbicides each independently is an acetyl CoA carboxylase inhibitor or an acetolactate synthase (ALS) inhibitor. More particular such OD compositions are those wherein one of the herbicides is an acetyl CoA carboxylase inhibitor; and the other one is an acetolactate synthase (ALS) inhibitor.

Specific such OD compositions comprise from about 3% to about 20% by weight said acetyl CoA carboxylase; from about 0.4% to about 10% by weight said acetolactate synthase (ALS) inhibitor; from about 0.2% to about 10% by weight said dispersant; from about 1% to about 25% by weight said surfactant; from about 40% to about 95% by weight said oil; from about 1% to about 10% by weight said safener; and from about 1% to about 10% by weight said thickening agent.

Examples of such compositions are those wherein said acetyl CoA carboxylase inhibitor is pinoxaden; said acetolactate synthase inhibitor is a triazolinone-based herbicide such as thiencarbazone-methyl or a sulfonylurea-based herbicide such as mesosulfuron-methyl; said dispersant is at least one, e.g., one, two, three, or more, of: (i) a block copolymer of polyethylene glycol and poly(12-hydroxystearic acid) (e.g., Zephrym™ PD 2206, Hypermer™ B246, and Atlox™ 4912), (ii) a copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30), (iii) a copolymer of polyisobutylene succinic anhydride and polyethylene glycol (e.g., Atlox™ 4914), and (iv) a polyethylene glycol sorbitol polyester of fatty acids, i.e., an ethoxylated sorbitol esterified with a polyester having, e.g., 2-6, fatty acid chains (e.g., Atlox™ 4916); said surfactant is polyethylene glycol sorbitol oleate such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); said oil is a vegetable oil such as canola oil; said safener is mefenpyr-diethyl; and said thickening agent is an organo-modified silica such as hydrophobic fumed silica.

More specific such compositions comprise: (i) from about from about 5% to about 15% by weight pinoxaden; from about 0.5% to about 2% by weight thiencarbazone-methyl; from about 0.5% to about 8% by weight said block copolymer of polyethylene glycol and poly(12-hydroxystearic acid) (e.g., Zephrym™ PD 2206, Hypermer™ B246, and Atlox™ 4912); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica; (ii) from about from about 5% to about 15% by weight pinoxaden; from about 0.5% to about 2% by weight thiencarbazone-methyl; from about 0.5% to about 8% by weight said polyethylene glycol sorbitol polyester of fatty acids, i.e., an ethoxylated sorbitol esterified with a polyester having, e.g., 2-6, fatty acid chains (e.g., Atlox™ 4916); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica; (iii) from about from about 5% to about 15% by weight pinoxaden; from about 0.5% to about 2% by weight thiencarbazone-methyl; from about 0.5% to about 8% by weight said copolymer of polyisobutylene succinic anhydride and polyethylene glycol (e.g., Atlox™ 4914); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica; (iv) from about from about 2% to about 15% by weight pinoxaden; from about 0.5% to about 3% by weight mesosulfuron-methyl; from about 0.5% to about 8% by weight said copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30); from about 2% to about 10% by weight said polyoxyethylene sorbitol oleate; from about 50% to about 90% by weight said vegetable oil; from about 1% to about 8% by weight mefenpyr-diethyl; from about 1% to about 6% by weight said hydrophobic fumed silica; and from about 2% to about 8% by weight said antioxidant.

Unless otherwise indicated, all numbers expressing, e.g., amounts of components, used in this specification, are to be understood as being modified in all instances by the term “about”. Accordingly, unless indicated to the contrary, the numerical parameters set forth in this specification are approximations that may vary by up to plus or minus 10% depending upon the desired properties to be obtained by the present invention.

The invention will now be illustrated by the following non-limiting Examples.

### EXAMPLES

### Materials and Methods

Materials. All reagents and starting materials were purchased from Hangzhou Udragon Chemical Co., Ltd., Evonik Industries, Cargill, Croda, Clariant, Solvay, DOW, Ashland Global Holdings Inc., and ADAMA Ltd.

### Example 1. Preparation of a Pinoxaden- and Thiencarbazone-Oil Dispersion Formulation

A formulation comprising the herbicides pinoxaden and thiencarbazone as detailed in Table 1 was prepared by the following procedure: (i) the reactor was checked to ensure it was water free; (ii) the reactor was charged with canola oil; (iii) the additives (dispersants and surfactants as shown in Table 2) and mefenpyr were added while mixing and mixing continued for at least 30 minutes to obtain a clear solution; (iv) then, pinoxaden and thiencarbazone were added and the mixing continued for at least 60 minutes; (v) Aerosil R-812S was added and the mixing continued for at least 30 minutes; (vi) the premix was milled with bead mill to particle size, d90 [μm]<12 μm. The particle size measurements were made using a Malvern Mastersizer 3000 instrument using a saturated solution. The saturated solution was prepared from a mixture of all the formulation components except the silica; and (vii) the obtained mixture was left stirring overnight and then sieved.

TABLE 1

| Component | Amount w/w (%) | Amount (g) for 1 L |
|---|---|---|
| pinoxaden | 10.2 | 102 |
| thiencarbazone | 0.85 | 8.5 |
| mefenpyr | 5.15 | 51.5 |
| Aerosil R-812S | 3 | 30 |
| additive | 20 | 200 |
| canola oil | 60.8 | up to 980 |
| total | 100 | 980 |

### Example 2. Evaluation of the Emulsions Obtained from the Pinoxaden- and Thiencarbazone-Oil Dispersion Formulations

After the preparation of pinoxaden-thiencarbazone-based formulations with various additives as described in Example 1, 1 g of formulation was dropped into 99 g of tap water and the obtained emulsions were evaluated. The results and the various additives tested are shown in Table 2.

TABLE 2

| | | | Milkiness^{d} | Gel | |
|---|---|---|---|---|---|
| | | | of | residue | |
| | | Blooming^{c} | emulsion | after 2 h | |
| | | (1-5; 1 is | (1-5; 1 is | (1-5; 1 is | Chemical |
| Additive^{a} | Chemical details | the best) | the best) | the best) | stability^{b} |
| Atlas 1086 10% | polyoxyethylene (40 EO) | 2 | 2 | 2 | |
| | sorbitol hexaoleate | | | | |
| Atlas 1086 20% | | 2 | 2 | 2 | |
| 15% Genopol XM- | Genopol XM-60 is | 4 | 4 | 5 | |
| 60 + 5% Genapol | isotridecyl alcohol | | | | |
| PF10 | ethoxylate methyl ether, | | | | |
| | 6 mol EO; Genopol PF10 | | | | |
| | is EO-PO-EO polymer | | | | |
| 10% Atlas G5002 | butyl ether-EO-PO-EO | 4 | 3 | 5 | |
| | polymer | | | | |
| 10% Atlas G5002 + | Aerosol OT is sodium | 4 | 3 | 5 | |
| 1% Aerosol OT | dioctylsulfosuccinate | | | | |
| 20% Tween 85 | polyoxyethylenesorbitan | 1 | 2 | 4 | |
| | trioleate | | | | |
| 20% Alkamuls OL-40 | castor oil ethoxylate | 3 | 2 | 2 | |
| | (40 EO) | | | | |
| 10% Atlox 4916 | | 5 | 4 | 5 | |
| 20% Ecosurf EH-6 | 2-ethylhexyl-PO-EO | 2 | 3 | 5 | |
| | (6 EO) polymer | | | | |
| 20% Ecosurf EH-6 + | | 2 | 3 | 5 | |
| 1% Aerosol OT | | | | | |
| 20% Arlaton TV | Arlaton TV is | 3 | 3 | 4 | |
| | polyoxyethylene (40) | | | | |
| | sorbitol peroleate | | | | |
| 5% Zephrym + | | 1 | 1 | 1 | Yes |
| 15% Atlas 1086 | | | | | |
| 1% Atlox 4916 + | | 1 | 1 | 2 | Yes |
| 15% Atlas 1086 | | | | | |

^{a}the amount of the additive(s) used was 20% by weight or filled up to 20% with canola oil.
^{b}chemical stable emulsions are those having <=5% decomposition, as measured by HPLC, of each one of the active ingredients after storage for two weeks at 54° C.
^{c}blooming is a subjective assessment made by the performer of the experiment. Good blooming occurs when the droplet disperses on its way down forming a white emulsion, and bad blooming is when the drop drops to the bottom and physical shaking is needed to disperse the formulation. In general, the blooming of OD formulations based on vegetable oil is very poor so the scores given in Table 2 are relative scores.
^{d}milkiness is a subjective assessment made by the performer of the experiment and is assessed after the emulsion is left to stand for 30 hrs. Good milkiness appears when the emulsion throughout the whole cylinder looks homogenous and very opaque. Poor milkiness is when the emulsion is not homogenous (normally the top of the cylinder is less opaque and more clear) and there is creaming at the top or precipitate at the bottom of the cylinder.

The results presented in Table 2 show that increasing the amount of Atlas G-1086, when used alone, did not solve the problem of the gel formation upon addition of water to the OD formulation. Moreover, none of the combinations of Genopol XM-60+Genapol PF10, Atlas G5002+Aerosol OT and Ecosurf EH-6+Aerosol OT resolved the gel residue formation. As shown in Table 2, none of Atlas G5002, Tween 85, Alkamuls OL-40, Atlox 4916, Ecosurf EH-6, and Arlaton TV, when used alone did not solve the gel residue formation as well. On the other hand, the combination of Zephrym+Atlas G-1086 and Atlox 4916+Atlas G-1086 enabled obtaining emulsions with significantly reduced amounts of gel residue, or even completely free of gel residue. Specific such emulsions were also tested to evaluate the chemical stability of the active ingredients and, as shown, the chemical stability of the active ingredients has been maintained. It has also been discovered by the inventors that a combination of 1% Atlox 4914+Atlas G-1086 reduced gel residue formation without causing degradation of the active ingredients.

### Example 3. Preparation of a Pinoxaden- and Mesosulfuron-Oil Dispersion Formulation

A formulation comprising the herbicides pinoxaden and mesosulfuron as depicted in Table 3 was prepared following the same procedure as described in Example 1.

TABLE 3

| Component | Amount w/w (%) | Amount for 1 L |
|---|---|---|
| mesosulfuron | 1.27 | 12.3 |
| pinoxaden | 6.25 | 60.6 |
| mefenpyr | 3.71 | 36.0 |
| Aerosil R-805 | 3.09 | 30.0 |
| additives | as shown in | |
| | Table 4 | |
| BHA^{a} | 5.15 | 50.0 |
| canola oil | filled to 100 | filled to 970 |
| total | 100 | 970.00 |

^{a}butylated hydroxyanisole.

### Example 4. Evaluation of the Emulsions Obtained from the Pinoxaden- and Mesosulfuron-Oil Dispersion Formulations

After the preparation of pinoxaden-mesosulfuron-based formulations with various additives as described in Example 3, 1 g of formulation was dropped into 99 g of tap water and the obtained emulsions were evaluated. The results and the various additives tested are shown in Table 4.

TABLE 4

| Additive | | Gel residue formation | | | Chemical |
|---|---|---|---|---|---|
| (%) | Emulsion | surface | bottle | sieve | stability^{a} |
| No additive | average | yes | yes | yes | |
| 5% Zephrym | average | yes | yes | yes | |
| 5% Atlas | good | yes | yes | yes | |
| 10% Atlas | not milky | yes | yes | yes | |
| 10% Atlas + | good | no | no | yes | yes |
| 0.75% Atlox 4916 | | | | | |
| 10% Atlas + | good | no | no | yes | yes |
| 1% Atlox 4916 | | | | | |
| 10% Atlas + | good | very | very | yes | |
| 1% Atlox 4912 | | small | small | | |
| | | amount | amount | | |
| 5% Atlas + | average | no | no | no | yes |
| 5% Agrimer Al-22 | | | | | |

^{a}chemical stable emulsions are those having <=5% decomposition, as measured by HPLC, of each one of the active ingredients.

The results presented in Table 4 show that without any additive or when Atlas G-1086 or Zephrym PD 2206 was used alone, gel residue was formed. The combinations of Atlas G-1086+Atlox 4916, Atlas G1086+Atlox 4912, and Atlas G-1086+Agrimer Al-22 enabled obtaining emulsions with significantly reduced amounts of gel residue, or even completely free of gel residue, while not causing the decomposition of the active ingredients.

### Example 5. Bio-Efficacy Trials of a Pinoxaden- and Thiencarbazone-Based OD Formulation

Objective. Evaluating the efficacy of pinoxaden- and thiencarbazone-based OD formulation under greenhouse conditions and comparing it with tank mix of commercial solo formulations of the same active ingredients applied in equivalent rate.

Location. Trials were conducted on behalf of ADAMA Ltd. at the Department of Weed Research in Newe-Ya'ar Research Center, Agricultural Research Organization, Ramat Yishay, Israel.

Materials and methods. All seeds were sown in plastic pots (pot volume of 300 cc) filled with Newe Ya'ar soil (medium-heavy clay-loam soil). From this stage and until the end of the experiment plants were kept in a temperature-controlled greenhouse (35-20° C.). Herbicide application was done outside the greenhouse in a dedicated chamber. Spray application was performed using motorized sprayer equipped with a flat fan 8001E nozzle 4 and operated at a pressure of 300 kPa with spray volume equivalent to 200 L/Hectare. Application of treatments was done using a common practice of applying from the lower to the higher rate and with water-rinsing of the equipment between applications. After herbicide application, pots were transferred back to greenhouse and were sprinkler-irrigated to a field capacity 4-hours after herbicide application. The formulations were applied either as preemergence or as post-emergence of the treated weeds.

Assessments. Each treatment was performed in 5 repetitions and an un-treated control was included for each weed species. Weed control was assessed on 3-4 occasions using a visual evaluation of 0-100 percentage scale, where 0=complete control and 100=no effect.

The tested weeds were Avena sativa, Setaria verticillata, and Lolium multiflorum.

### Post-Emergence Trial

The OD formulation comprising pinoxaden 100 gr/L+thiencarbazone 8.3 gr/L+mefenpyr-methyl 49.8 gr/L and the additives Atlas G-1086 150 gr/L and Zephrym PD 2206 50 g/L was compared to a tank mix (a mix of available products, each comprising a different one of pinoxaden and thiencarbazone, in water) and applied post-emergence.

The tank mix was composed of pinoxaden 100 EC, which is an emulsifiable concentrate (active ingredient: pinoxaden, 100 g/L); and Varro® herbicide, which is an OD formulation (active ingredient: thiencarbazone-methyl, 10 g/L).

The adjuvant Agral (nonyl phenol ethylene oxide condensate), was added to some of the tested treatments according to the recommended label rate, at 0.25% of the total tank spray volume (v/v), i.e., the total volume obtained after mixing the tested formulation with water, before application.

The control used in the trial was untreated weed.

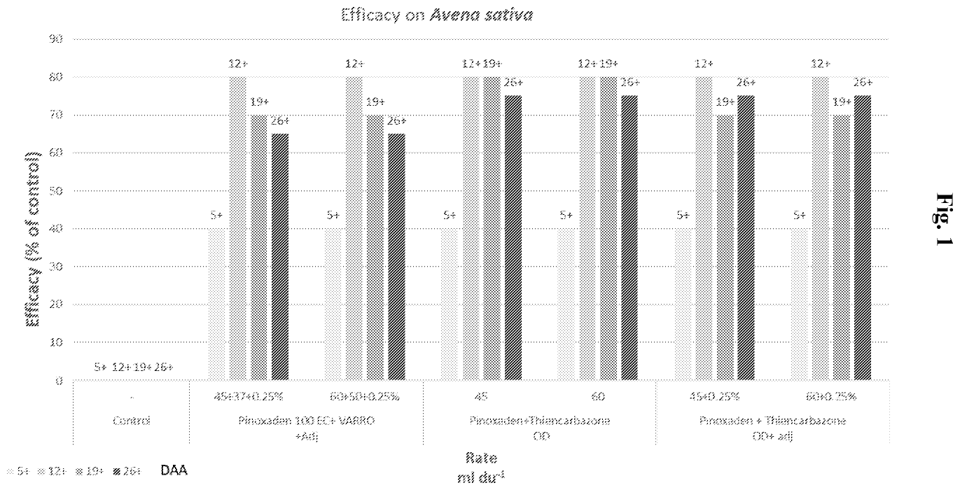

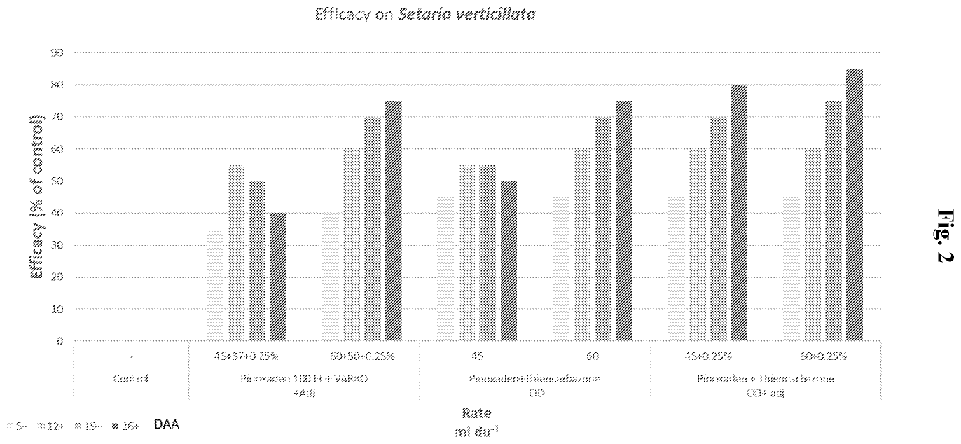

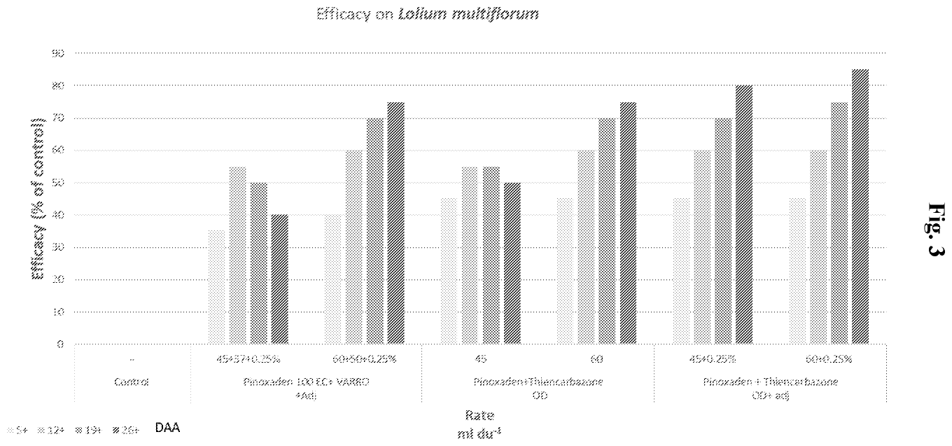

Results. The efficacy of the tested pinoxaden- and thiencarbazone-based OD formulation as compared to the tank mix, applied post emergence, in controlling the various weeds tested is shown in FIG. 1-3. The OD formulation, even without an adjuvant, was shown to be superior or equivalent to the tank mix with an addition of an adjuvant in controlling the grassy weeds Avena sativa, Setaria verticillata, and Lolium multiflorum.

1. An oil dispersion (OD) composition comprising: (i) an herbicide; (ii) a dispersant selected from a polyhydroxy ester-polyethylene glycol copolymer, an alkylated N-vinylpyrrolidinone copolymer, an alkyd polyethylene glycol resin, a star structure polymer, and a mixture thereof; (iii) a surfactant selected from polyethylene glycol sorbitol ester of fatty acids; and (iv) an oil.

2. The OD composition of claim 1, wherein said polyethylene glycol sorbitol ester of fatty acids is a polyethylene glycol sorbitol ester of oleic acid such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); a polyethylene glycol sorbitol ester of a mixture of oleic and lauric acids such as polyoxyethylene (30) oleate-laurate (e.g., Atlox™ 1045A); or a mixture thereof.

3. The OD composition of claim 1 or 2, wherein said polyhydroxy ester-polyethylene glycol copolymer is a block copolymer of polyethylene glycol and poly(12-hydroxystearic acid) (e.g., Zephrym™ PD 2206, Hypermer™ B246, and Atlox™ 4912); said alkylated N-vinylpyrrolidinone copolymer is a copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22); and a copolymer of 1-eicosene and N-vinyl 2-pyrrolidone (such as a 30:70 copolymer of N-vinyl 2-pyrrolidone and 1-eicosene, e.g., Agrimer AL™ 30); said alkyd polyethylene glycol resin is a copolymer of polyisobutylene succinic anhydride and polyethylene glycol (e.g., Atlox™ 4914); and said star structure polymer is a polyethylene glycol sorbitol polyester of fatty acids, i.e., an ethoxylated sorbitol esterified with a polyester having, e.g., 2-6, fatty acid chains (e.g., Atlox™ 4916).

4. The OD composition of any one of claims 1-3, wherein: (i) said oil is a triglyceride fatty acid ester such as a vegetable oil, seed oil, and animal oil; or a monoester derived from a vegetable, seed, or animal oil; or a mixture thereof; and/or (ii) said composition further comprises a safener such as cloquintocet, benoxacor, cyometrinil, cyprosulfamide, dichlormid, dicyclonon, dietholate, fenchlorazole ethyl, fenclorim, flurazole, fluxofenim, furilazole, isoxadifen ethyl, mefenpyr diethyl, mephenate, naphthalic anhydride, oxabetrinil, a derivative thereof such as agriculturally acceptable salt and an ester thereof (e.g., cloquintocet-mexyl), and a mixture thereof.

5. The OD composition of any one of claims 1-4, further comprising a thickening agent such as a clay, a modified clay, a silica, a modified silica, and a mixture thereof.

6. The OD composition of any one of claims 1-5, wherein said herbicide is an acetyl CoA carboxylase inhibitor, an acetolactate synthase (ALS) inhibitor, or a mixture thereof.

7. The OD composition of claim 6, wherein said herbicide consists of a mixture of two herbicides each independently selected from the group consisting of an acetyl CoA carboxylase inhibitor or an acetolactate synthase (ALS) inhibitor.

8. The OD composition of claim 7, wherein one of said herbicides is an acetyl CoA carboxylase inhibitor; and the other one is an acetolactate synthase (ALS) inhibitor.

9. The OD composition of claim 8, wherein said acetyl CoA carboxylase inhibitor is pinoxaden; and said acetolactate synthase inhibitor is a triazolinone-based herbicide such as thiencarbazone-methyl or a sulfonylurea-based herbicide such as mesosulfuron-methyl.

10. The OD composition of claim 1, further comprising: (i) a safener; (ii) a thickening agent; and optionally (iii) an antioxidant.

11. The OD composition of claim 10, wherein one of said herbicides is an acetyl CoA carboxylase inhibitor; and the other one is an acetolactate synthase (ALS) inhibitor.

12. The OD composition of claim 11, comprising from about 3% to about 20% by weight said acetyl CoA carboxylase; from about 0.4% to about 10% by weight said acetolactate synthase (ALS) inhibitor; from about 0.2% to about 10% by weight said dispersant; from about 2% to about 25% by weight said surfactant; from about 40% to about 95% by weight said oil; from about 1% to about 10% by weight said safener; and from about 1% to about 10% by weight said thickening agent.

13. The OD composition of claim 12, wherein said acetyl CoA carboxylase inhibitor is pinoxaden; said acetolactate synthase inhibitor is a triazolinone-based herbicide such as thiencarbazone-methyl or a sulfonylurea-based herbicide such as mesosulfuron-methyl; said dispersant is at least one of: (i) a block copolymer of polyethylene glycol and poly(12-hydroxystearic acid) (e.g., Zephrym™ PD 2206, Hypermer™ B246, and Atlox™ 4912), (ii) a copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30), (iii) a copolymer of polyisobutylene succinic anhydride and polyethylene glycol (e.g., Atlox™ 4914), and (iv) a polyethylene glycol sorbitol polyester of fatty acids, i.e., an ethoxylated sorbitol esterified with a polyester having, e.g., 2-6, fatty acid chains (e.g., Atlox™ 4916); said surfactant is a polyethylene glycol sorbitol oleate such as polyoxyethylene (40) sorbitol hexaoleate (e.g., Atlas® G-1086 and Cirrasol® G-1086) and polyoxyethylene (50) sorbitol hexaoleate (e.g., Atlas® G-1096 and Cirrasol® G-1096); said oil is a vegetable oil such as canola oil; said safener is mefenpyr-diethyl; and said thickening agent is an organo-modified silica such as hydrophobic fumed silica.

14. The OD composition of claim 13, comprising:
(i) from about from about 5% to about 15% by weight pinoxaden; from about 0.5% to about 2% by weight thiencarbazone-methyl; from about 0.5% to about 8% by weight said block copolymer of polyethylene glycol and poly(12-hydroxystearic acid) (e.g., Zephrym™ PD 2206, Hypermer™ B246, and Atlox™ 4912); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica;
(ii) from about from about 5% to about 15% by weight pinoxaden; from about 0.5% to about 2% by weight thiencarbazone-methyl; from about 0.5% to about 5% by weight said polyethylene glycol sorbitol polyester of fatty acids, i.e., an ethoxylated sorbitol esterified with a polyester having, e.g., 2-6, fatty acid chains (e.g., Atlox™ 4916); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica;
(iii) from about from about 5% to about 15% by weight pinoxaden; from about 0.5% to about 2% by weight thiencarbazone-methyl; from about 0.5% to about 8% by weight said copolymer of polyisobutylene succinic anhydride and polyethylene glycol (e.g., Atlox™ 4914); from about 5% to about 20% by weight said polyethylene glycol sorbitol oleate; from about 50% to about 90% by weight said vegetable oil; from about 2% to about 8% by weight mefenpyr-diethyl; and from about 1% to about 6% by weight said hydrophobic fumed silica; or
(iv) from about from about 2% to about 15% by weight pinoxaden; from about 0.5% to about 3% by weight mesosulfuron-methyl; from about 2% to about 8% by weight said copolymer of a monoalkene and N-vinyl 2-pyrrolidone such as a copolymer of 1-hexadecene and N-vinyl 2-pyrrolidone (such as a 20:80 copolymer of 1-hexadecene and N-vinyl 2-pyrrolidone, e.g., Agrimer™ AL 22) and a copolymer of 1-eicosene and N-vinyl 2-pyrrolidone (such as a 30:70 copolymer of N-vinyl 2-pyrrolidone and 1-eicosene, e.g., Agrimer AL™ 30); from about 1% to about 15% by weight said polyoxyethylene sorbitol oleate; from about 50% to about 90% by weight said vegetable oil; from about 1% to about 8% by weight mefenpyr-diethyl; from about 1% to about 6% by weight said hydrophobic fumed silica; and from about 2% to about 8% by weight said antioxidant.

15. A method of controlling weed comprising applying to a locus such as a field of crop an effective amount of a composition according to any one of claims 1-14.
